(19) United States
(12) Patent Application Publication
(10) Pub. No.: US 2025/0216868 A1
(43) Pub. Date: Jul. 3, 2025

(54) ANTI-SATURATION CONTROL METHOD AND DEVICE FOR UNMANNED AERIAL VEHICLE BASED ON LEAD CORRECTION

(71) Applicant: Autel Robotics Co., Ltd., Shenzhen (CN)

(72) Inventor: Baoxu JIA, Shenzhen (CN)

(21) Appl. No.: 19/004,356

(22) Filed: Dec. 29, 2024

(30) Foreign Application Priority Data
Dec. 29, 2023 (CN) 202311868580.1

(51) Int. Cl. G05D 1/83; G05D 109/25

(52) U.S. Cl. CPC G05D 1/83; G05D 2109/254

(57) ABSTRACT

The present application provides an anti-saturation control method and device for an unmanned aerial vehicle based on lead correction, where the method includes determining a first rotational speed of a plurality of actuators of the unmanned aerial vehicle from a pre-set lead correction algorithm; re-determining, when the first rotational speed satisfies a saturation limit condition, the first rotational speed satisfying the saturation limit condition as a second rotational speed in a critical saturation state; calculating an anti-saturation acceleration corresponding to the second rotational speed from the lead correction algorithm; and controlling the unmanned aerial vehicle to fly according to the anti-saturation acceleration. In the above scheme, the lag effect and command saturation of the actuator are taken into account simultaneously, and the lead correction algorithm is combined with the anti-saturation processing organically, so that the anti-saturation acceleration can be restored after undergoing an actuator allocation link and a lead correction link, and the anti-saturation allocation of the actuator with different lag effect can also be processed, so as to improve the flight accuracy of the unmanned aerial vehicle.

### BACKGROUND

### Technical Field

The present application relates to the technical field of unmanned aerial vehicles, and in particular, to an anti-saturation control method and device for an unmanned aerial vehicle based on lead correction.

### Related Art

When a multi-rotor unmanned aerial vehicle flies, there are maximum and minimum rotational speed limits, which may be encountered in large maneuver or extreme flight, which is called rotational speed saturation. If the problem of rotational speed saturation is not dealt with in any way, it may result in the unmanned aerial vehicle attitude being out of control, which may lead to the complete uncontrolled fall of the aircraft. In order to ensure flight stability and maximize the performance of unmanned aerial vehicles, anti-saturation processing is usually required.

The most classical of the common anti-saturation methods is the anti-saturation algorithm in px4, however, in px4 and other known anti-saturation algorithms, the lag effect of the actuator and the lead correction algorithm used to deal with the lag effect are not considered. However, the command obtained by the lead correction cannot completely correspond to the set command after the anti-saturation processing, and there is a certain deviation, thereby affecting the control accuracy.

### SUMMARY

The embodiments of the present application provide an anti-saturation control method and device for an unmanned aerial vehicle based on lead correction, so as to solve the technical problem of poor command control accuracy caused by the difficulty in simultaneously considering the lag effect of an actuator and the problem of command saturation in the prior art.

In a first aspect, an embodiment of the present application provides an anti-saturation control method for an unmanned aerial vehicle based on lead correction, which includes
determining a first rotational speed of a plurality of actuators of the unmanned aerial vehicle from a pre-set lead correction algorithm;
re-determining, when the first rotational speed satisfies a saturation limit condition, the first rotational speed satisfying the saturation limit condition as a second rotational speed in a critical saturation state;
calculating an anti-saturation acceleration corresponding to the second rotational speed from the lead correction algorithm; and
controlling the unmanned aerial vehicle to fly according to the anti-saturation acceleration.

Alternatively, the anti-saturation control method for an unmanned aerial vehicle based on lead correction includes:
determining, from a flight state of the unmanned aerial vehicle, that at least one of a plurality of channels of the unmanned aerial vehicle is a target channel, other channels are reference channels, and each of the channels is configured with a respective acceleration;
the calculating the anti-saturation acceleration corresponding to the second rotational speed from the lead correction algorithm includes:
calculating an anti-saturation acceleration of the target channel from the second rotational speed and the lead correction algorithm.

Alternatively, the calculating the anti-saturation acceleration of the target channel from the second rotational speed and the lead correction algorithm includes:
determining an acceleration of the reference channel;
calculating a third rotational speed before the second rotational speed correction from the lead correction algorithm and the second rotational speed; and
determining the anti-saturation acceleration of the target channel from the acceleration of the reference channel, the third rotational speed and a pre-set control allocation matrix.

Alternatively, the re-determining, when the first rotational speed satisfies the saturation limit condition, the first rotational speed satisfying the saturation limit condition as the second rotational speed in the critical saturation state includes:
determining whether a first rotational speed of the actuator is greater than a pre-set saturation rotational speed;
if so, re-determining the first rotational speed satisfying the saturation limit condition as the second rotational speed in the critical saturation state.

Alternatively, after the determining whether a first rotational speed of the actuator is greater than a pre-set saturation rotational speed; further including:
determining whether a first rotational speed of the plurality of actuators is greater than a pre-set saturation rotational speed;
if so, the calculating the anti-saturation acceleration corresponding to the second rotational speed from the lead correction algorithm includes:
calculating respective anti-saturation accelerations corresponding to second rotational speeds of the plurality of actuators; and
determining the minimum of the anti-saturation accelerations as an anti-saturation acceleration.

Alternatively, the determining the first rotational speed of the plurality of actuators of the unmanned aerial vehicle from the pre-set lead correction algorithm includes:
obtaining an initial acceleration;
determining an initial rotational speed of the plurality of actuators from the initial acceleration in combination with a pre-set control allocation equation; and
correcting the initial rotational speed according to the lead correction algorithm to obtain the first rotational speed.

Alternatively, the correcting the initial rotational speed according to the lead correction algorithm to obtain the first rotational speed includes:
determining an inertial model of the actuator corresponding to the first rotational speed;
determining a phase compensation formula from the inertial model; and
calculating the first rotational speed from the phase compensation formula and the initial rotational speed.

Alternatively, the controlling the unmanned aerial vehicle to fly according to the anti-saturation acceleration includes:
recalculating a first rotational speed of the actuator from the anti-saturation acceleration and a pre-set control allocation equation, where the recalculated first rotational speed is a rotational speed of the actuator reallocated according to the anti-saturation acceleration; and
correcting the recalculated first rotational speed according to the lead correction algorithm, recalculating a second rotational speed of the actuator, where the recalculated second rotational speed is an actuator rotational speed that is not performed lead correction; where
the actuator is made to be responsive to the recalculated second rotational speed to control the unmanned aerial vehicle to fly.

In a second aspect, the present application also provides an anti-saturation control device for an unmanned aerial vehicle based on lead correction, which includes
a control allocation module configured to determine a first rotational speed of a plurality of actuators of the unmanned aerial vehicle from a pre-set lead correction algorithm;
an anti-saturation feedback module configured to re-determine, when the first rotational speed satisfies a saturation limit condition, the first rotational speed satisfying the saturation limit condition as a second rotational speed in a critical saturation state;
a command correction module configured to calculate an anti-saturation acceleration corresponding to the second rotational speed from the lead correction algorithm; and
a flight control module configured to control the unmanned aerial vehicle to fly according to the anti-saturation acceleration.

In a third aspect, embodiments of the present application provide an electronic device, including a memory, a processor and a computer program stored in the memory and capable of running on the processor, where the processor, when executing the computer program, implements a method as described in the first aspect.

In a fourth aspect, the embodiment of the present application provides a computer readable storage medium, which has stored thereon a computer program including program commands which, when executed by a processor, cause the processor to perform the method according to the first aspect.

The embodiment of the present application provides an anti-saturation control method for an unmanned aerial vehicle based on lead correction. Firstly, a corrected first rotational speed of an actuator on an unmanned aerial vehicle is determined from a pre-set lead correction algorithm, and if the first rotational speed satisfies a saturation limit condition, the first rotational speed is re-determined as a second rotational speed in a critical saturation state, then an initial anti-saturation acceleration is back-calculated with the second rotational speed, and finally the unmanned aerial vehicle is controlled to fly with the anti-saturation acceleration. In the above-mentioned scheme, the first rotational speed of the actuator is re-determined as the second rotational speed after being subjected to saturation limit condition, and then the second rotational speed is a theoretical rotational speed after anti-saturation; however, since the actuator also has a lag effect, it is impossible to directly calculate the anti-saturation acceleration according to the second rotational speed, and it is also necessary to determine the original rotational speed corresponding to the second rotational speed by combining the second rotational speed with the lead correction algorithm, and then calculate the anti-saturation acceleration according to the control allocation. Thus, the unmanned aerial vehicle again enables the actual rotational speed of the actuators to be the theoretical second rotational speed according to the anti-saturation acceleration command, control allocation of the actors, and again through the lead correction, thereby controlling the unmanned aerial vehicle to fly and improving the control accuracy of the unmanned aerial vehicle.

### BRIEF DESCRIPTION OF THE DRAWINGS

In order to explain the embodiments of the present invention or the technical solutions in the prior art more clearly, a brief description will be given below of the drawings which need to be used in the embodiments. It is obvious that the drawings in the following description are only some embodiments of the present invention, and it would have been obvious for a person skilled in the art to obtain other drawings according to these drawings without involving any inventive effort.

FIG. 1 is a schematic diagram of an application scenario of an anti-saturation control method for an unmanned aerial vehicle according to an embodiment of the present application;

FIG. 2a is a schematic flow chart of a control allocation method for an unmanned aerial vehicle in the prior art;

FIG. 2b is a schematic flow chart of another control allocation method for an unmanned aerial vehicle in the prior art;

FIG. 3 is a schematic flow chart of an anti-saturation control method for an unmanned aerial vehicle based on lead correction according to an embodiment of the present application;

FIG. 4 is a schematic diagram of an anti-saturation control method according to an embodiment of the present application;

FIG. 5 is a schematic flow chart of a method for calculating a first rotational speed of an actuator based on a lead correction algorithm according to an embodiment of the present application;

FIG. 6 is a schematic flow chart of a method for calculating anti-saturation acceleration according to an embodiment of the present application;

FIG. 7 is a schematic flow chart of an anti-saturation control method according to an embodiment of the present application;

FIGS. 8a, b, c, and d are graphs comparing set accelerations and actual accelerations of a roll, pitch, yaw, and throttle channels provided in an experimental embodiment of the present application, respectively;

FIGS. 9a, b, c, and d are graphs comparing a set acceleration and an actual acceleration of a roll, pitch, yaw, and throttle channels provided in a comparative example of the present application, respectively;

FIG. 10 is a schematic diagram of an architecture of an anti-saturation control device for an unmanned aerial vehicle based on lead correction according to an embodiment of the present application; and

FIG. 11 is a schematic diagram of an architecture of an electronic device according to an embodiment of the present application.

### DETAILED DESCRIPTION

In order that the objects, aspects and advantages of the present invention will become more apparent, a more particular description of the invention will be rendered by reference to the embodiments thereof which are illustrated in the appended drawings. It should be understood that the particular embodiments described herein are illustrative only and are not limiting. Based on the embodiments of the present invention, all other embodiments obtained by a person skilled in the art without inventive effort fall within the scope of the present invention.

It should be noted that, if not conflicting, various features of the embodiments of the present invention may be combined with each other within the scope of the present invention. In addition, although the division of functional modules is illustrated in a schematic diagram showing a device and a logical order is illustrated in a flowchart, in some cases, the steps illustrated or described may be performed in an order other than the division of the modules the device or in the flowchart. Furthermore, the words “first”, “second”, “third”, etc., as used herein do not limit the data and order of execution, but merely distinguish the same item or similar item having substantially the same function or action.

Firstly, the application environment of the anti-saturation control method for an unmanned aerial vehicle provided by an embodiment of the present application is introduced.

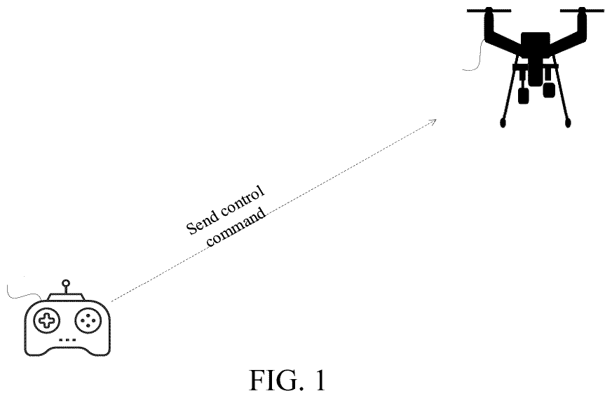

Referring to FIG. 1, FIG. 1 is a schematic diagram of an application scenario of an anti-saturation control method for an unmanned aerial vehicle 200 provided by an embodiment of the present application. The method provided by the embodiments of the present application can be applied to an unmanned aerial vehicle 200 as shown in FIG. 1, where the unmanned aerial vehicle 200 can perform wireless communication with a control terminal 100 on the ground, and the control terminal 100 can send a control command to the unmanned aerial vehicle 200, and the unmanned aerial vehicle 200 includes a rack, a controller and a power system communicatively connected to the controller, and the controller can receive the control command and control actuators to mutually work according to the control command so that the unmanned aerial vehicle 200 executes the control command.

The control terminal 100 is located on the ground to send control commands to the unmanned aerial vehicle 200. In some embodiments, the control terminal 100 may be a remote controller on the ground or a server cluster composed of one or more servers. The control terminal 100 transmits an electromagnetic wave carrying a control command to the unmanned aerial vehicle 200 through a signal base station on the ground or directly by the control terminal 100.

The frame includes a fuselage and an undercarriage, where the fuselage includes a center frame and a plurality of arms connected to the center frame, and the plurality of arms extend radially from the center frame to carry the power system of the unmanned aerial vehicle 200. The undercarriage is connected to the fuselage for supporting the unmanned aerial vehicle 200 when landing.

A power system is disposed on the fuselage and includes a plurality of rotors and a motor drivingly coupled to the rotors, the motor being communicatively coupled to the controller. After receiving the control command from the controller, the motor works in a set rotation direction and rotational speed, and drives the rotor to rotate together therewith, and when the rotor rotates, a negative pressure is generated so that the unmanned aerial vehicle 200 can fly, and according to the rotation direction and rotational speed of a plurality of different rotors, the unmanned aerial vehicle 200 can fly in different attitudes and directions.

The controller is also mounted on the fuselage, and the controller can control the unmanned aerial vehicle 200 to fly according to a pre-set program, and can also control the unmanned aerial vehicle 200 to fly in response to a control command from the control terminal 100. In some embodiments, the unmanned aerial vehicle 200 is also provided with a plurality of sensors, such as infrared cameras, LiDAR, gyroscopes, inertial measurement units, etc. The data monitored by the sensor is fed back to the controller, and the controller directly adjusts the flight parameters of the unmanned aerial vehicle 200 according to the acquired data or sends the data to the control terminal 100 on the ground, and then adjusts the flight parameters of the unmanned aerial vehicle 200 according to the control command sent by the control terminal 100.

Based on the above hardware scenario, the control allocation method for an unmanned aerial vehicle in the prior art is introduced.

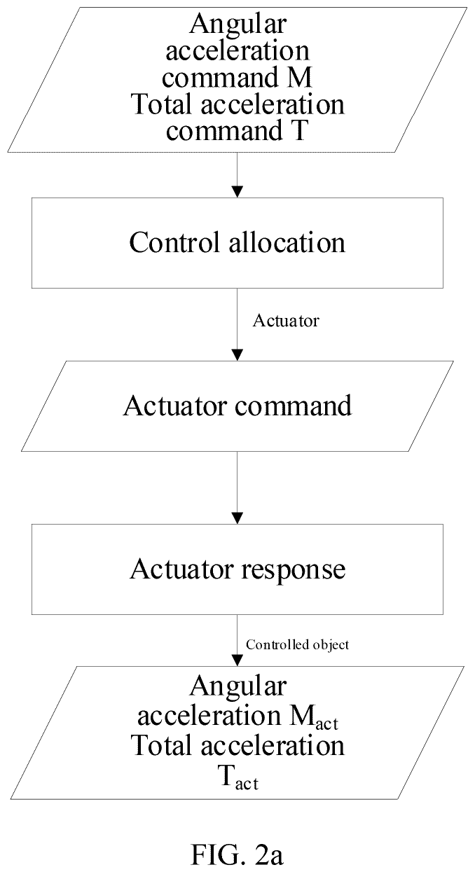

Referring to FIG. 2a, FIG. 2a is a schematic flow chart of a control allocation method for an unmanned aerial vehicle in the prior art. The unmanned aerial vehicle has a number of different independent control command input channels according to different types, each channel is used to receive a control command, and the control command of each channel ultimately needs to be allocated to a plurality of actuators of the unmanned aerial vehicle. After a plurality of control commands are superimposed, the rotational speed of each actuator is obtained through control allocation, and the actuators work according to the rotational speed, so that the unmanned aerial vehicle can fly according to the control commands. Taking a multi-rotor unmanned aerial vehicle as an example, the targets for its final control are typically an angular acceleration command for controlling attitude and a total acceleration command for controlling altitude. After calculating the angular acceleration and acceleration commands for controlling attitude and altitude, it is necessary to allocate them to a plurality of actuators, such as motors, to obtain commands for each actuator.

Referring to FIG. 2b, FIG. 2b is a schematic flow chart of another control allocation method for an unmanned aerial vehicle in the prior art. Since the response of the actuator has lag, and the response will act on a controlled object (such as a multi-rotor unmanned aerial vehicle) to generate the actual angular acceleration and acceleration, the actual angular acceleration and acceleration of the controlled object also has lag as compared with the previous angular acceleration and acceleration command, so that the unmanned aerial vehicle cannot precisely fly according to the control command. In order to eliminate this lag as much as possible, it is necessary to compensate for the lag of the actuator. That is, after the acceleration command is subjected to control allocation to obtain the actuator command, the actuator command is performed lead correction to improve the phase and eliminate the lag, so that the actuator can better respond according to the actuator command, so that the actual angular acceleration and total acceleration of the controlled object coincide with the initial angular acceleration command and total acceleration command. However, although the lead correction algorithm increases the phase, it is likely to cause a problem of command saturation, and therefore an anti-saturation processing is required. The anti-saturation processing in the prior art usually does not take into account the effect of the lead correction, but this results in that the command obtained after the control allocation is no longer the expected command due to the effect of the lag effect of the actuator, resulting in a reduced flight control accuracy of the unmanned aerial vehicle.

Based on the above-mentioned application scenario, prior art and technical problems thereof, an anti-saturation control method for an unmanned aerial vehicle provided by an embodiment of the present application is described below.

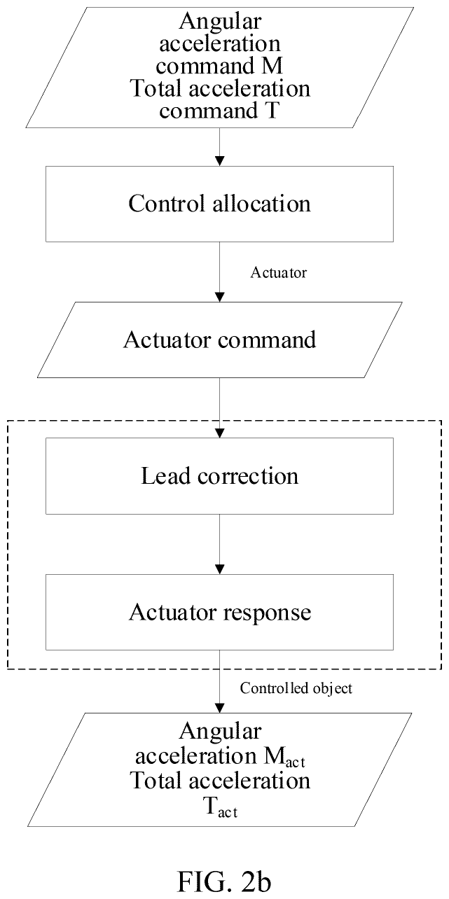

Referring to FIG. 3, FIG. 3 is a schematic flow chart of an anti-saturation control method for an unmanned aerial vehicle based on lead correction provided by an embodiment of the present application, the method including:

S31 Determine a first rotational speed of a plurality of actuators of the unmanned aerial vehicle from a pre-set lead correction algorithm.

In this step, the actuator is a driving device of the unmanned aerial vehicle for providing power to the unmanned aerial vehicle to achieve and control flight. In some embodiments, there are a plurality of actuators, each actuator is drivingly connected to a rotor of the unmanned aerial vehicle such that the rotor is driven to rotate by the actuator to generate power, and the power generated by the plurality of actuators driving the plurality of rotors to rotate is coordinated with each other such that the unmanned aerial vehicle is capable of movement in one or more degrees of freedom. In particular embodiments, the actuator is a driving motor, and the actuator adjusts the rotational speed according to control commands from the controller to enable the unmanned aerial vehicle to rotate about one or more rotation axes. For example, the rotation axes may include a Roll, a Yaw, and a Pitch.

In this step, the lead correction algorithm is an algorithm used to compensate for a lag effect of the actuator. When the unmanned aerial vehicle is disturbed, the original rotational speed of the actuator cannot reflect the change of the control command immediately, but only after a certain time. For example, the control command adjusts an input first rotational speed of the target actuator at the current moment, so that the actual rotational speed of the target actuator is also adjusted to the first rotational speed; however, due to a lag effect, the actual rotational speed will be adjusted to the first rotational speed after several times, and the control command has changed at this time, so that the unmanned aerial vehicle cannot fly according to the expected control command. Therefore, the lead correction algorithm can improve the phase of the control command, so as to make up for the phase lag caused by the lag effect, and the first rotational speed of the control command adjusted by the lead correction algorithm can make the unmanned aerial vehicle fly according to the set control command and reduce the error. In some embodiments, if the first rotational speed is not adjusted by the lead correction algorithm, there is a lag effect in the control command, and the purpose of precisely controlling the unmanned aerial vehicle to fly by the control command cannot be achieved. However, by calculating the original rotational speed input to the target actuator according to the first rotational speed adjusted by the lead correction algorithm, the control command obtained cannot only make the actual rotational speed of the target actuator consistent with the saturation rotational speed, but also improve the response speed of the unmanned aerial vehicle to the control command, thereby improving the control accuracy of the unmanned aerial vehicle.

In this step, the first rotational speed is defined as the rotational speed at which the controller allocates the control command to the actuator according to the original control command and performs lead correction. For example, the control command of the unmanned aerial vehicle may be broken down into a plurality of channel movements that are independent of each other, such as lifting, flipping, and pitching. The controller allocates original rotational speed for the corresponding actuator according to the action of each channel in the original control command, and the original rotational speed is corrected by a lead correction algorithm to obtain the first rotational speed. The principle of the lead correction algorithm and the calculation process of the first rotational speed are described in detail later, and will not be described here.

S32 Re-determine, when the first rotational speed satisfies a saturation limit condition, the first rotational speed satisfying the saturation limit condition as a second rotational speed in a critical saturation state.

In this step, the second rotational speed is defined as the maximum rotational speed or minimum rotational speed of the actuator under safe operating environment and physical limit conditions, i.e., the saturation rotational speed under critical saturation condition. For example, a deflection angle and a deflection speed of a rudder of the unmanned aerial vehicle are limited, and the rotational speed of the motor is limited by the maximum of the physical structure. When the first rotational speed of the actuator exceeds the saturation rotational speed, i.e., when an input signal from the controller to the actuator exceeds the limit, closed-loop control performance of the actuator decreases, resulting in the actuator failing to operate stably or even no longer responding to the control command. Apparently, when the first rotational speed of the actuator slightly exceeds the saturation rotational speed, the influence on the actuator is relatively small, and at this time, by reducing the first rotational speed to be less than or equal to the saturation rotational speed, for example, the first rotational speed is re-determined as the second rotational speed in the present embodiment, it can be ensured that the actuator re-operates stably, which is an anti-saturation strategy. If the first rotational speed higher than the saturation rotational speed being allocated to the actuator is disregarded, or the adjustment to the first rotational speed is delayed, an accident might have been caused. It will be appreciated that the saturation rotational speed may also be a limited minimum rotational speed, the actuator directly setting the first rotational speed to the minimum rotational speed when the input first rotational speed is less than the minimum rotational speed.

In this step, the saturation limit condition is used to determine whether a rotational speed of the actuator has reached the saturation rotational speed. For example, if the first rotational speed of the actuator is less than or equal to the saturation rotational speed, then the actuator does not satisfy the saturation limit condition, and the actuator operates directly in response to the first rotational speed. On the contrary, if the first rotational speed of the actuator is greater than the saturation rotational speed, the actuator satisfies the saturation limit condition. If the first rotational speed of the actuator meets the saturation limit condition, the first rotational speed of the actuator needs to be re-determined as the second rotational speed.

In some embodiments, the unmanned aerial vehicle has a plurality of actuators, and there may be a plurality of actuators at the same time that satisfy the saturation limit condition, and accordingly all of the actuator rotational speeds that satisfy the saturation limit condition need to be determined as the second rotational speed. It should be noted that the second rotational speed (i.e., the saturation rotational speed) of different actuators may differ from each other due to different specifications.

In this step, the first rotational speed is re-determined as the second rotational speed, and instead of directly controlling the rotational speed of the actuator, the unmanned aerial vehicle control command is re-determined based on the second rotational speed. For example, if the first rotational speed is changed directly during the flight, the unmanned aerial vehicle cannot fly according to the control command, and even can cause the unmanned aerial vehicle to run out of control, for example, because the balance of the unmanned aerial vehicle in the pitching channel is broken due to the change of the rotational speed of the actuator, the unmanned aerial vehicle cannot maintain the flight attitude.

S33 Calculate an anti-saturation acceleration corresponding to the second rotational speed from the lead correction algorithm.

In this step, the anti-saturation acceleration is a control command for controlling the unmanned aerial vehicle. Specifically, the control command includes an acceleration command for each channel, and the anti-saturation acceleration is an anti-saturation acceleration obtained by back-calculating with a lead correction algorithm based on the second rotational speed. The detailed calculation process is described later, and will not be described here.

S34 Control the unmanned aerial vehicle to fly according to the anti-saturation acceleration.

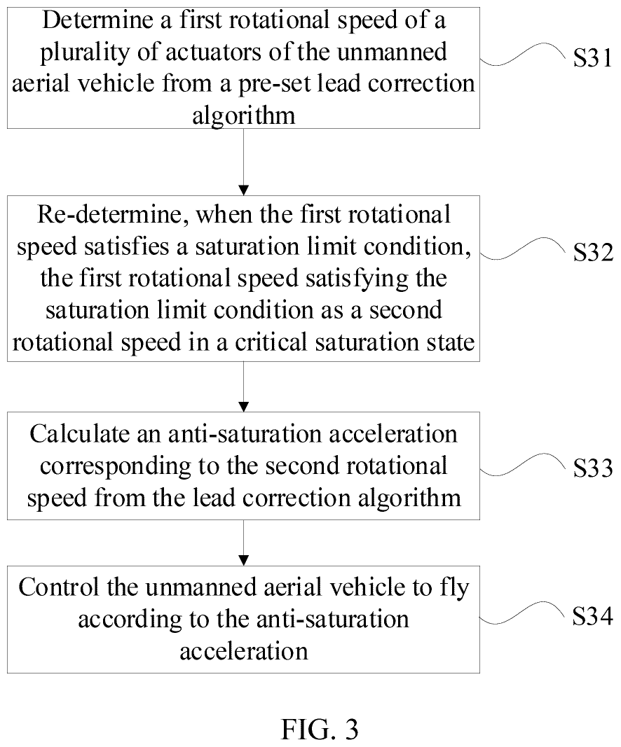

In this step, the control over the unmanned aerial vehicle is realized by a control command, and the control command is used for controlling the unmanned aerial vehicle to perform a flight action according to the control command. In some embodiments, the control command specifically includes setting acceleration of a plurality of channels of the unmanned aerial vehicle, where the channels include, for example, lifting, pitching, rolling and yawing, and the number of channels can be any number of channels, and each channel corresponds to one acceleration of the unmanned aerial vehicle. In some embodiments, the control command may have a pre-set target value, for example, the control command sets the acceleration to 20 m/s², or may have no pre-set target value, for example, the rudder is pushed so that the unmanned aerial vehicle yaws in the direction, and the unmanned aerial vehicle determines the acceleration to 20 m/s² according to the pushing amplitude. For example, referring to FIG. 4, FIG. 4 is a schematic diagram of an anti-saturation control method according to an embodiment of the present application. According to the anti-saturation acceleration, the unmanned aerial vehicle performs control allocation to the actuator again, and makes corresponding lead correction, finally makes the controlled object fly according to the control command in response to the actuator.

In other embodiments, the control command may be sent by a control terminal, for example, the ground determines the position of the unmanned aerial vehicle by visual or image transmission means and sends the control command to operate the unmanned aerial vehicle to fly, and may also be autonomously generated by a controller of the unmanned aerial vehicle, for example, in the process of power patrol, the unmanned aerial vehicle automatically identifies obstacles and performs obstacle avoidance flight through a terrain database and image recognition technology.

The above-mentioned technical solution organically combines the lead correction algorithm and the anti-saturation processing under the condition of fully considering the lag characteristic and the command saturation of the actuator, so that the anti-saturation acceleration can be truly restored after undergoing an actuator allocation link and a lead correction link, thereby improving the accuracy of controlling the unmanned aerial vehicle to fly.

A specific method for calculating the first rotational speed from the lead correction algorithm in an embodiment of the present application is described below.

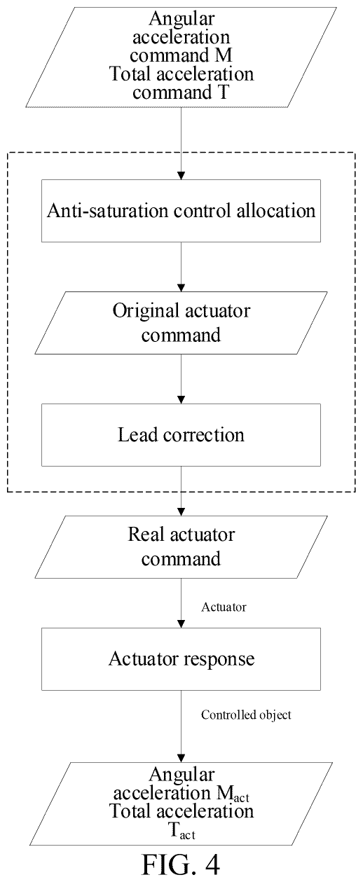

Referring to FIG. 5, FIG. 5 is a schematic flow chart of a method for calculating a first rotational speed of an actuator from a lead correction algorithm in an embodiment of the present application, the method including:

S510 Determine an initial acceleration.

S520 Determine an initial rotational speed of the plurality of actuators from the initial acceleration in combination with a pre-set control allocation equation.

S530 Correct the initial rotational speed according to the lead correction algorithm to obtain the first rotational speed.

In S510, the initial acceleration is determined from the initial control command and the current flight state of the unmanned aerial vehicle. For example, when the unmanned aerial vehicle is currently in a cruising state and receives an initial control command, for example, yawing 30 degrees to the left, a corresponding initial angular speed is generated according to the current flight state and the initial control command. The unmanned aerial vehicle then controls specific components to cooperate to fly according to the initial control commands based on the initial angular speed. The initial acceleration is represented as [M1 M2 M3 T], where M1, M2, and M3 are the angular accelerations of the pitch, roll, and yaw channels in rad/s², respectively, and T is the acceleration command of the total throttle in m/s².

In S520, the pre-set control allocation equation includes a control allocation equation and a control efficiency equation. The expression of the control allocation equation may refer to the following exemplary formula:

$${[ {ω}_{r 1}^{2} {ω}_{r 2}^{2} {ω}_{r 3}^{2} {ω}_{r 4}^{2} ]}^{T} = {B}_{CA} * {[ M 1 M 2 M 3 T ]}^{T}$$

where B_{CA} is a control allocation matrix and ωᵣ₁², ωᵣ₂², ωᵣ₃², and ωᵣ₄² are the square of the rotational speeds of the four actuators respectively.

The control efficiency equation may be expressed referring to the following exemplary formula:

$${[ \begin{matrix}M 1 & M 2 & M 3 & T\end{matrix} ]}^{T} = {B}_{C E} * {[ \begin{matrix}{ω}_{r 1}^{2} & {ω}_{r 2}^{2} & {ω}_{r 3}^{2} & {ω}_{r 4}^{2}\end{matrix} ]}^{T}$$

where B_{CE} is a control efficiency matrix.

An initial rotational speed ω_{ri_ori} of the actuator can thus be calculated from the initial acceleration [M1 M2 M3 T] in combination with a known control allocation matrix B_{CA}, where i=1, 2, 3, . . . , n.

In S530, the step of correcting the initial rotational speed according to the lead correction algorithm to obtain the first rotational speed may further include:

S531 Determine an inertial model of the actuator corresponding to the first rotational speed.

S532 Determine a phase compensation formula from the inertial model.

S533 Calculate the first rotational speed from the phase compensation formula and the initial rotational speed.

In S531, the inertial model is defined as a mathematical model for describing the lag effect of the target actuator. It can be understood that the inertial model is an abstraction and generalization of the lag effect in the physical sense of the target actuator, and the values calculated or fitted by the inertial model only have high similarity with the actual values in a certain range, and the accuracy and scope of application of the results obtained by different inertial models are also different. For example, in some embodiments, for motor-controlled rotor rotation, the inertial model is described in terms of a
first-order differential equation as:

$${u}_{a} = \frac{1}{τ s + 1} {u}_{c}$$

where u_{c} is a set rotational speed, uₐ is an actual rotational speed, τ is a time constant of the inertia link, and s is a complex parameter. The definition of inertia link is that when the input is abrupt, the output cannot be abrupt, but can change gradually according to the exponential law, which reflects that this link has inertia. The inertia link will lead to a phase lag of control command compared with the actual situation, if it is not processed, the control accuracy of control command will be reduced.

In S532, the phase compensation formula is defined as a mathematical formula for calculating the phase to compensate for the lag effect of the target actuator. When the inertial model is known, the phase amount required to be advanced in order to compensate the lag time can be back-calculated from the inertial model. For example, for the inertial model described above, the compensation formula can be calculated as:

$${G}_{L e a d} ( s ) = τ s + 1$$

where G_{Lead}(S) is a phase compensation parameter.

In some embodiments, it may be desirable to discretize the phase compensation formula after determining the phase compensation formula for ease of calculation. For example, the following can be obtained by discretizing the phase compensation formula according to the backward difference method:

$${G}_{L e a d} ( z ) = τ ( 1 - {z}^{- 1} ) + 1$$

where z is a complex variable of a complex plane domain obtained by z-transforming the variable s in the compensation formula. It is to be understood that the discretization method is not limited to the backward difference method described in the present embodiment, but may be a forward difference method or a bilinear transformation method in a numerical integration method, or may be a step method or an impulse response invariant method in an input response invariant method, which is not limited here.

In S533, a first rotational speed can be determined from the phase compensation formula and the initial rotational speed, and the calculation formula can refer to the following exemplary formula:

$${u}_{l e a d} ( k ) = τ ( {u}_{c} ( k ) - {u}_{c} ( k - 1 ) ) + {u}_{c} ( k )$$

where u_{lead} dis a first rotational speed, T is a time constant of the inertia link, and u_{c} is an original rotational speed. T is a constant that can be determined experimentally or empirically.

A specific method for calculating the anti-saturation acceleration provided by one embodiment of the present application is described below.

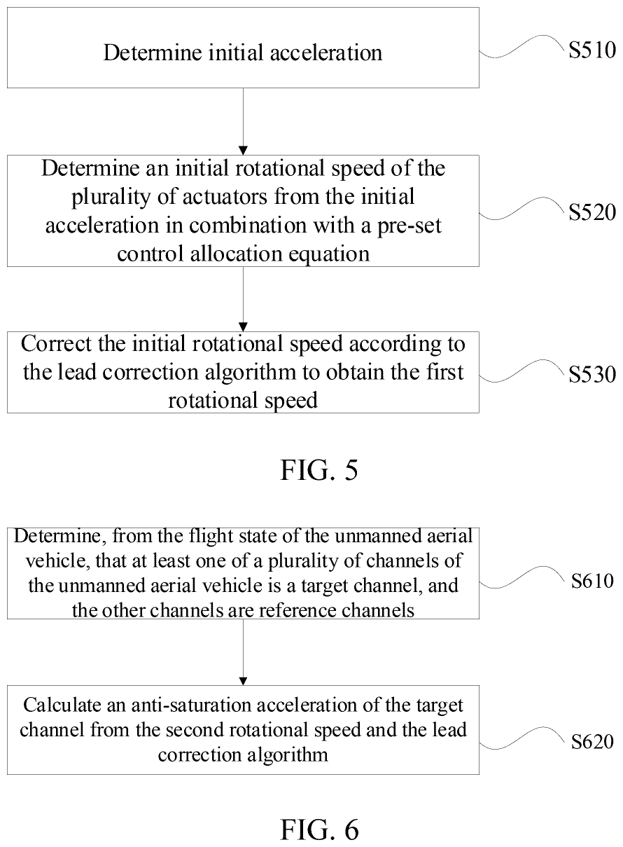

Referring to FIG. 6, FIG. 6 is a schematic flow chart of a method for calculating an anti-saturation acceleration provided by an embodiment of the present application, the method including: S610 Determine, from a flight state of the unmanned aerial vehicle, that at least one of a plurality of channels of the unmanned aerial vehicle is a target channel, other channels are reference channels, and each of the channels is configured with a respective acceleration.

S620 Calculate an anti-saturation acceleration of the target channel from the second rotational speed and the lead correction algorithm.

In S610, the target channel is defined as a channel for keeping the unmanned aerial vehicle attitude stable and needing to sacrifice the dynamic parameters, and the reference channel is a channel other than the target channel. In particular, under different flight states of the unmanned aerial vehicle, each channel has different importance for attitude stability and therefore has different priorities. For example, when the flight state of the unmanned aerial vehicle is fixed-point hovering, the unmanned aerial vehicle needs to keep a certain position in space, so both of its roll and pitch channels must be stable, otherwise the unmanned aerial vehicle may roll out of control. In contrast, yaw is generally not a critical parameter in fixed-point hover, because the unmanned aerial vehicle does not need to rotate at this time, i.e., the effect of rotating the unmanned aerial vehicle on fixed-point hovering is small, so in the fixed-point hovering, the yaw channel is the target channel. As another example, when the flight state of the unmanned aerial vehicle is cruising, the roll and pitch channels still have to remain stable, while the yaw channel is also important when the unmanned aerial vehicle needs to turn or change directions, so only the throttle can sacrifice, i.e., reducing the speed of the unmanned aerial vehicle to keep the flight attitude stable, and the throttle is the target channel. By way of further example, when the unmanned aerial vehicle flight state is agile tracking, the unmanned aerial vehicle needs to change direction quickly and frequently according to the target position, so the roll and pitch channels must remain stable during the unmanned aerial vehicle maneuver to ensure that the unmanned aerial vehicle has fast lateral and longitudinal response. The yaw channel also has a higher priority in the fast-tracking state to ensure that the unmanned aerial vehicle can quickly turn to the target, so it can also choose to sacrifice the throttle, i.e., reduce the unmanned aerial vehicle flight speed to ensure that the unmanned aerial vehicle can track the target stably. In summary, in each flight state, the so-called target channel generally refers to a channel whose parameters are sacrificed in order to maintain the critical motion of the unmanned aerial vehicle in that state, and the other channels, as reference channels, are channels directly used to provide stability for the critical motion. The unmanned aerial vehicle flight control system needs to consider roll, pitch, yaw and throttle channels to achieve stable, smooth and maneuver flight. Different missions may require different channel configurations and control strategies, so the importance of the parameters may vary depending on the specific application scenario. In the design of the control system, system modeling and simulation are usually needed to optimize the parameter configuration.

With regard to the roll, pitch, yaw and throttle channels of the unmanned aerial vehicle, it can be seen from the above-mentioned three embodiments that neither the rolling channel nor the pitching channel is selected as the target channel, because if the unmanned aerial vehicle is out of control due to over-saturation in the rolling and pitching channels, the unmanned aerial vehicle is likely to directly roll over and rapidly crash, leaving little time for the unmanned aerial vehicle to perform attitude adjustment. On the contrary, if the unmanned aerial vehicle is out of control in yaw and/or lifting channel, the unmanned aerial vehicle can keep a stable flight attitude while flying, although it does not precisely fly toward the target according to the control command, and there is a relatively large amount of time to readjust the attitude of the unmanned aerial vehicle. In some embodiments, the lift, yaw, pitch, and roll channels are in a prioritized order. It will be appreciated that the nature of the anti-saturation control allocation is to sacrifice control over the target channel to some extent, thereby preserving complete and accurate control over other reference channels to maintain the flight state of the unmanned aerial vehicle. It should be noted that in some embodiments, the flight attitude of the unmanned aerial vehicle is first determined, and then the yaw channel or the lifting channel is specifically determined as the target channel according to the stability effect of different channels on the flight attitude. It is to be understood that a person skilled in the art can selectively determine any channel as the target channel according to the structure of the unmanned aerial vehicle and the flight mission, etc., which is not limited here.

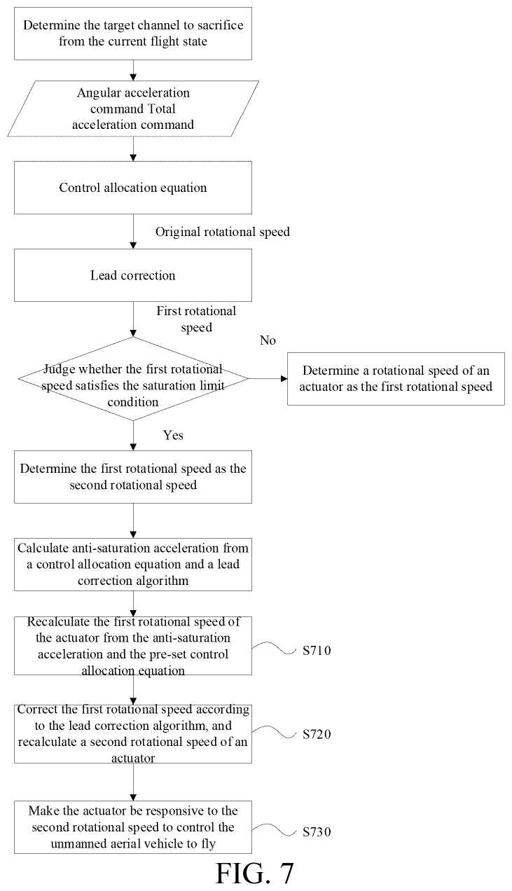

In step S610, the step of determining the target channel according to the flight state of the unmanned aerial vehicle may be performed when it is determined that command saturation occurs, i.e., when performing the above-mentioned step S33, or may be performed before the unmanned aerial vehicle performs the first control allocation according to the initial control command to determine the first rotational speed of the actuator, i.e., before performing the above-mentioned step S31, or may be performed synchronously and in parallel at any time between the two steps, i.e., between step S31 and step S33. Specifically, referring to FIG. 7, FIG. 7 is a schematic flow chart of an anti-saturation control method according to an embodiment of the present application. The unmanned aerial vehicle first determines the target channel to sacrifice according to the current flight state. Then, the unmanned aerial vehicle acquires the angular acceleration command and the total acceleration command, and performs the first control allocation according to the angular acceleration command and the total acceleration command and the control allocation equation, and calculates the original rotational speed of each actuator without anti-saturation processing. Then, the first rotational speed is obtained by performing lead correction on the original rotational speed according to the lead correction algorithm. At this time, it is determined whether or not the first rotational speed satisfies the saturation limit condition, and if not, it is indicated that the first rotational speed at this time is not saturated, and the actuator may directly operate according to the first rotational speed. If so, the unmanned aerial vehicle re-determines the first rotational speed as the second rotational speed in the critical saturation state. According to the second rotational speed combined with the lead correction algorithm, the rotational speed of the second rotational speed that is not performed lead correction is back-calculated, and then combining the rotational speed that is not performed lead correction with the control allocation equation, the corresponding angular acceleration and total acceleration is back-calculated (since the acceleration at this moment corresponds to the second rotational speed, and the second rotational speed is re-determined for anti-saturation of the first rotational speed, the angular acceleration and total acceleration are anti-saturation accelerations). Finally, control allocation and lead correction are performed again according to the anti-saturation acceleration to obtain a new second rotational speed, and the actuator is operated according to the new second rotational speed to control the unmanned aerial vehicle to fly. It will be appreciated that the first step, i.e., the step of determining the target channel from the current flight state, may be provided at any position prior to the step of determining the first rotational speed as the second rotational speed.

In S620, the calculating the anti-saturation acceleration of the target channel from the second rotational speed and the lead correction algorithm includes:

S621 Determine an acceleration of the reference channel.

S622 Calculate a third rotational speed before the second rotational speed correction from the lead correction algorithm and the second rotational speed.

S623 Determine the anti-saturation acceleration of the target channel from the acceleration of the reference channel, the third rotational speed and a pre-set control allocation matrix.

In step S621, it can be seen from the above that the initial acceleration [M1 M2 M3 T] is a known parameter, and in the case of determining the target channel, the acceleration of the reference channel can be determined directly. For example, if the target channel is a throttle, the acceleration M1, M2, and M3 of the channel may be referred to.

In step S622, it can be seen from the definition of the second rotational speed that if the first rotational speed of the actuator is greater than the pre-set saturation rotational speed, the rotational speed of the actuator is re-determined as the second rotational speed, i.e.,
when ω_{r1_on_lead}>ωₘₐₓ, let ω_{r1_on_lead}=ωₘₐₓ. Thus, according to the lead correction algorithm, the uncorrected third rotational speed can be calculated from the following exemplary formula:

$${ω}_{r 1 \_ antisat} ( k ) = ( {ω}_{max} + τ {ω}_{r 1 \_ antisat} ( k - 1 ) ) / ( τ + 1 )$$

where ω_{r1_antisat} is a third rotational speed, ωₘₐₓ is a second rotational speed (i.e., a saturation rotational speed), and T is a time constant.

In step S623, the following equation is obtained by a transformation in mathematical form in combination with the above control allocation equation:

$${ω}_{r 1}^{2} = {B}_{C A} ( 1 , 1 : 4 ) * {[ \begin{matrix}M 1 & M 2 & M 3 & T\end{matrix} ]}^{T}$$

where B_{CA}(1,1:4) is the first-row part of the control allocation matrix, i.e., B_{CA}(1,1:4) is a 4×1 matrix, e.g., [−300, 300, 300, −300]. [M1 M2 M3 T]^{T} is a 1×4 matrix, such that the product of the two matrices is exactly one element value, i.e., ωᵣ₁². ωᵣ₁ is equivalent to ω_{r1_antisat}, then ωᵣ₁² is known, B_{CA}(1,1:4) is known, and M1, M2, and M3 are known in the equation, from which the anti-saturation acceleration of the target channel can be calculated, with reference to the following exemplary formula:

$${T}_{a n t i s a t} = \frac{{ω}_{r 1 \_ antisat}^{2} - {B}_{C A} ( 1 , 1 : 3 ) * {[ \begin{matrix}M 1 & M 2 & M 3 & T\end{matrix} ]}^{T}}{{B}_{C A} ( 1 , 4 )}$$

where Tₐₙₜᵢₛₐₜ is the anti-saturation acceleration of the target channel, B_{CA}(1,1:3) is the first to third columns of the first row in the control allocation matrix, i.e., B_{CA}(1,1:3) is a 3×1 matrix, [M1 M2 M3]T is a 1×3 matrix, and the product of the two is an element value, which can be operated with ω_{r1_antisat}². B_{CA}(1,4) is an element value of the fourth column of the first row in the control allocation matrix.

Referring again to FIG. 7, in some embodiments, determining whether the first rotational speed satisfies the saturation limit condition further includes: whether a first rotational speed of the plurality of actuators is greater than a pre-set saturation rotational speed is determined. If there are a plurality of actuators with the first rotational speed greater than the saturation rotational speed, the above steps are respectively repeated to calculate the anti-saturation acceleration of the target channel corresponding to each actuator. Finally, the minimum of the plurality of anti-saturation accelerations is determined as the final anti-saturation acceleration of the target channel. For example, if both the first rotational speed A1 of the actuator A and the first rotational speed B1 of the actuator B are greater than the respective saturation rotational speeds, then for the actuator A, the first rotational speed A1 is re-determined as the second rotational speed A2, then the anti-saturation acceleration M_{A} is calculated from the second rotational speed A2 in combination with the control allocation equation and the lead correction algorithm, then the anti-saturation acceleration M_{B} for the actuator B is calculated from the same procedure, and if M_{A}>M_{B}, then the anti-saturation acceleration is determined as M_{B}, and then the first rotational speed and the second rotational speed are re-calculated from the anti-saturation acceleration M_{B}. Conversely, if M_{A}<M_{B}, the anti-saturation acceleration is determined to be M_{A}, and the first rotational speed and the second rotational speed are subsequently recalculated from the anti-saturation acceleration M_{A}. Since a plurality of actuators sacrifice the acceleration of the target channel to ensure the stability of the acceleration of other reference channels, and each actuator needs to keep its set rotational speed less than or equal to the saturation rotational speed, the set rotational speed of each actuator can be ensured to be less than or equal to its respective saturation rotational speed only by selecting the minimum of a plurality of anti-saturation accelerations.

A method for controlling the unmanned aerial vehicle to fly based on anti-saturation acceleration is described below. Specifically, referring again to FIG. 7, the method includes the steps of:

S710 Recalculate the first rotational speed of the actuator according to the anti-saturation acceleration and the pre-set control allocation equation.

S720 Correct the first rotational speed according to the lead correction algorithm, and recalculate a second rotational speed of an actuator.

S730 Make the actuator be responsive to the second rotational speed to control the unmanned aerial vehicle to fly.

In particular, a new control command [Mₐₙₜᵢₛₐₜ, Tₐₙₜᵢₛₐ] can be derived from the anti-saturation acceleration, in combination with the above control allocation equation:

$${[ \begin{matrix}{ω}_{r {1}_{a n a i s a t}}^{2} & {ω}_{r {2}_{antisat}}^{2} & {ω}_{r {3}_{a n t i s a t}}^{2} & {ω}_{r {4}_{a n t i s a t}}^{2}\end{matrix} ]}^{T} = {B}_{C A} * {[ \begin{matrix}M 1 & M 2 & M 3 & {T}_{anti s a t}\end{matrix} ]}^{T}$$

ω_{ri_antisat} can thus be obtained, i.e., a re-determined first rotational speed. Then, the re-determined second rotational speed is calculated by combining the above-mentioned lead correction algorithm, and the specific formula is as follows:

$${ω}_{ri \_ antisat \_ lead} ( k ) = τ ( {ω}_{ri \_ antisat} ( k ) - {ω}_{ri \_ antisat} ( k - 1 ) ) + {ω}_{ri \_ antisat} ( k )$$

ω_{ri_antisat_lead} is the re-determined second rotational speed. Finally, the actuator operates in response to the re-determined second rotational speed to control the unmanned aerial vehicle to fly according to the control command.

The technical effects of the technical solution of the present application are further illustrated by taking an experiment as an example.

In this experimental embodiment, the unmanned aerial vehicle is a four-rotor aircraft, and the unmanned aerial vehicle has four channels, i.e., roll, pitch, yaw and lifting channels, and the corresponding dynamic parameters are M1, M2, M3 and T, where the M1, M2 and M3 are in rad*s\hat{ }(−2), and the unit of T is in m*s\hat{ }(−2). The unmanned aerial vehicle has four actuators, specifically motors, and the rotational speeds of the four motors are ωᵣ₁, ωᵣ₂, ωᵣ₃, and ωᵣ₄, respectively. Then, the rotational speed of the motor can be calculated from the control command, and the formula is as follows:

$${[ \begin{matrix}M 1 & M 2 & M 3 & T\end{matrix} ]}^{T} = {B}_{C E} * {[ \begin{matrix}{ω}_{r 1}^{2} & {ω}_{r 2}^{2} & {ω}_{r 3}^{2} & {ω}_{r 4}^{2}\end{matrix} ]}^{T}$$

where B_{CE} is a control efficiency matrix, specifically:

$${B}_{CE} = [ \begin{matrix}- 300 & 300 & 300 & - 300 \\ 250 & - 250 & 250 & - 250 \\ 30 & 30 & - 30 & - 30 \\ 10 & 10 & 10 & 10\end{matrix} ] * {10}^{- 8}$$

B_{CE} is an empirical value, it can be found that for the control over different channels of the unmanned aerial vehicle, the roll and pitch channels have a greater influence on each actuator, while the yaw and lift channels have a lower influence on the actuator, so they can be used to sacrifice control and keep the control over roll and pitch channels. 10⁻⁸ is a conversion factor for dimension, since ωᵣ₁ is usually expressed in rpm, and M1 is in rad*s\hat{ }(−2).

In this experimental embodiment, the variation law of the maximum ωₘₐₓ=8000 of the saturation rotational speed, the minimum ωₘᵢₙ=1500 of the saturation rotational speed, the angular acceleration, and the acceleration control command with respect to time t is specified as follows:

$$M 1 = 50 + 30 * sin ( 35 t + 30 * pi / 180 )$$

$$M 2 = - 40 + 40 * sin ( 20 t + 120 * pi / 180 )$$

$$M 3 = 5 + 5 * sin ( 22 t + 70 * pi / 180 )$$

$$T = 10 + 10 * sin ( t + 60 * pi / 180 )$$

In this experimental example, the first-order inertia link model is established for all the four actuators according to the first-order differential equation, and the time constants of the four actuators are respectively 0.04 s, 0.08 s, 0.12 s and 0.16 s, i.e.,

$${ω}_{r 1 \_ act} = \frac{1}{0.04 s + 1} {ω}_{r 1 \_ cmd}$$

$${ω}_{r 2 \_ act} = \frac{1}{0.08 s + 1} {ω}_{r 2 \_ cmd}$$

$${ω}_{r 3 \_ act} = \frac{1}{0.12 s + 1} {ω}_{r 3 \_ cmd}$$

$${ω}_{r 4 \_ act} = \frac{1}{0.16 s + 1} {ω}_{r 4 \_ cmd}$$

where ω_{r1_cmd}, ω_{r2_cmd}, ω_{r3_cmd}, and ω_{r4_cmd} represent the command issued to the actuator and ω_{r1_act}, ω_{r2_act}, ω_{r3_act}, and ω_{r4_act} represent the actual rotational speed of the actuator. The acceleration and angular acceleration commands resulting from the actual rotational speeds of the four actuators are as follows:

$${[ \begin{matrix}M {1}_{a c t} & M {2}_{a c t} & M {3}_{a c t} & {T}_{a c t}\end{matrix} ]}^{T} = {B}_{C E} * {[ {ω}_{r 1 \_ act}^{2} {ω}_{r 2 \_ act}^{2} {ω}_{r 3 \_ act}^{2} {ω}_{r 4 \_ act}^{2} ]}^{T}$$

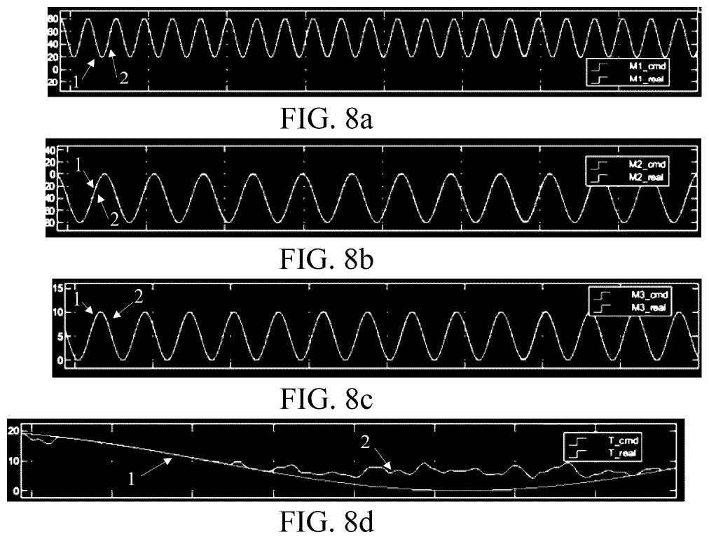

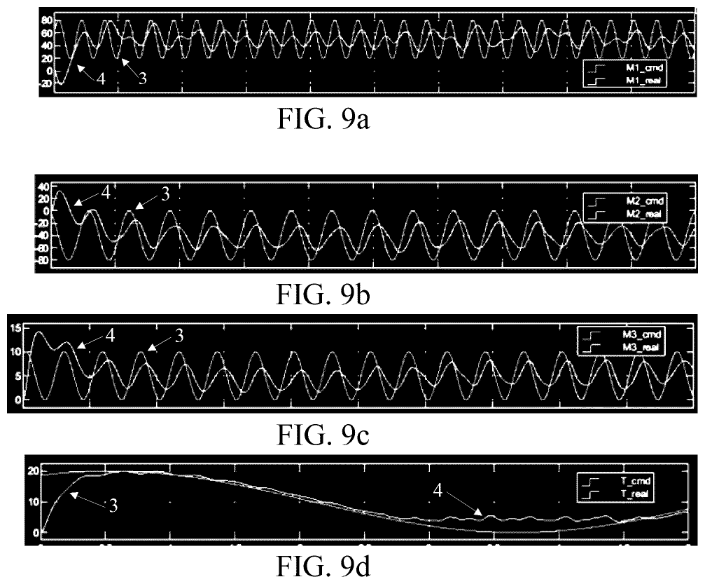

referring to FIGS. 8 and 9, FIGS. 8a, b, c and d are graphs comparing the set acceleration and the actual acceleration of the roll, pitch, yaw and throttle channels respectively provided by the experimental embodiment of the present application; FIGS. 9a, b, c, and d are graphs comparing the set acceleration and the actual acceleration of the roll, pitch, yaw, and throttle channels provided in the comparative example of the present application, respectively.

In FIGS. 8a, 8b and 8c, the curve labeled 1 represents the set acceleration of the command, and the curve labeled 2 represents the actual acceleration, from which it can be determined that the roll, pitch and yaw channels pass through the anti-saturation control method for the present application, and the actual acceleration is stable and consistent with the command acceleration. However, in comparison with FIGS. 9a, 9b and 9c, the curve labeled 3 represents the set acceleration and the curve labeled 4 represents the actual acceleration, and there is a certain deviation and phase lag between the set acceleration and the actual acceleration of the roll, pitch and yaw channels.

Again, comparing FIG. 8d with FIG. 9d, the curve labeled 1 in FIG. 8d is the set acceleration, the curve labeled 2 is the actual acceleration, the curve labeled 3 in FIG. 9d is the set acceleration, and the curve labeled 4 is the actual acceleration. By comparing curve 1 with curve 2, curve 3 with curve 4, it can be seen that in the embodiment of the present application, the deviation degree between the set acceleration and the actual acceleration of the throttle allocated via anti-saturation control allocation is greater than that in the prior art, because the stability of the throttle is sacrificed, and the stability of other important channels such as roll, pitch and yaw channels is replaced.

It can be seen therefrom that when the anti-saturation control allocation method provided by the embodiments of the present application is used, the allocation of the roll, pitch and yaw channels is more accurate, so that a real three-axis angular acceleration can better track commands, so as to achieve accurate control over the attitude. However, another control allocation method, which does not take into account the lag effect of the actuator, has obvious deviation between the three-axis angular acceleration and the command, and can significantly reduce the control accuracy of the attitude.

In summary, the embodiment of the present application provides an anti-saturation control method for a multi-rotor unmanned aerial vehicle, in which a lead correction algorithm is used to make up for the lag effect of an actuator, and at the same time, for the problem of easy command saturation caused by the lead correction algorithm, the rotational speed before the lead correction is calculated by back-calculation, so that the situations with different lag characteristics of a plurality of actuators can be effectively handled, and the actual rotational speed of the actuators can be realized according to the set rotational speed of a control command so as to improve the control accuracy of the unmanned aerial vehicle, while keeping the flight attitude of the unmanned aerial vehicle stable.

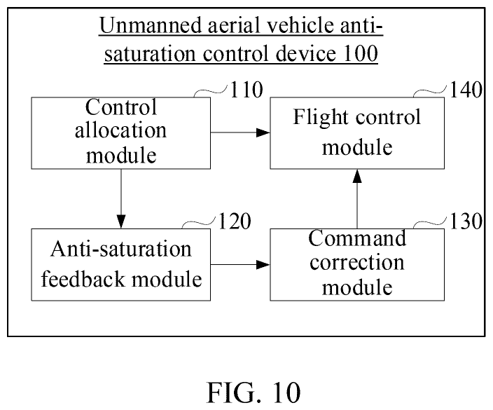

An embodiment of the present application also provides an anti-saturation control device for an unmanned aerial vehicle based on lead correction. Referring to FIG. 10, FIG. 10 is a schematic diagram of an architecture of an anti-saturation control device for an unmanned aerial vehicle based on lead correction according to an embodiment of the present application. The unmanned aerial vehicle anti-saturation control apparatus 100 includes a control allocation module 110, an anti-saturation feedback module 120, a command correction module 130, and a flight control module 140.

The control allocation module 110 is configured to determine a first rotational speed of a plurality of actuators of the unmanned aerial vehicle from a pre-set lead correction algorithm. Specifically, the control allocation module 110 can calculate an original rotational speed of each actuator according to an initial control command, perform lead correction on the original rotational speed according to a lead correction algorithm, and calculate to obtain a first rotational speed of the actuator.

The anti-saturation feedback module 120 is configured to re-determine, when the first rotational speed satisfies a saturation limit condition, the first rotational speed satisfying the saturation limit condition as a second rotational speed in a critical saturation state. Specifically, the anti-saturation feedback module 120 can determine whether a first rotational speed of each actuator exceeds a saturation rotational speed, and if so, re-determine it as a second rotational speed to achieve anti-saturation feedback to avoid actuator rotational speed saturation.

The command correction module 130 is configured to calculate an anti-saturation acceleration corresponding to the second rotational speed from the lead correction algorithm. Specifically, the command correction module 130 can calculate a rotational speed that is not performed lead correction corresponding to the second rotational speed according to the re-determined second rotational speed, and analytically restore same to obtain a corresponding anti-saturation acceleration, i.e., obtaining a corrected anti-saturation control command.

The flight control module 140 is configured to control the unmanned aerial vehicle to fly according to the anti-saturation acceleration. Specifically, if the unmanned aerial vehicle triggers the saturation limit condition, the flight control module 140 re-controls and allocates same to determine the rotational speed of each actuator according to the anti-saturation acceleration (i.e., a corrected anti-saturation control command) so as to perform control allocation on the unmanned aerial vehicle to fly; and if the unmanned aerial vehicle does not trigger the saturation limit condition, the flight control module 140 performs control allocation on the same according to the initial control command so as to control the unmanned aerial vehicle to fly.

Embodiments of the present application also provide a computer-readable storage medium storing a computer program including program commands which, when executed by a computer, cause the computer to perform the method according to the preceding embodiments.

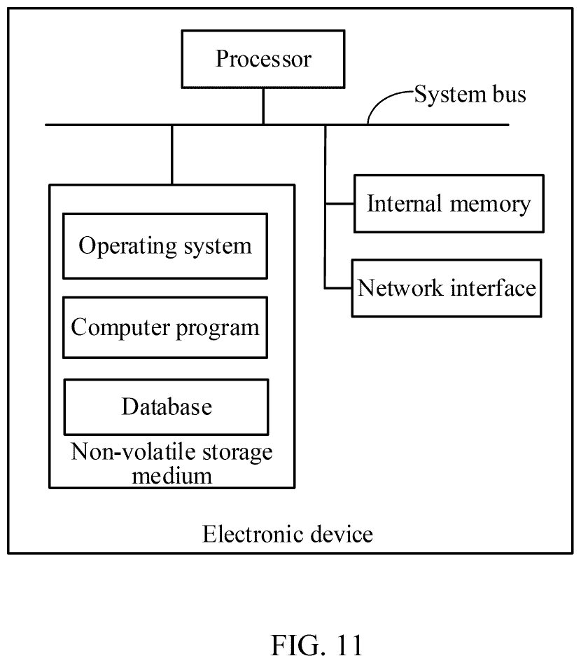

An embodiment of the present application also provides an electronic device including a memory, a processor and a computer program stored in the memory and operable on the processor, and an internal structure diagram thereof can be as shown in FIG. 11, and when the computer program is executed by the processor, the unmanned aerial vehicle anti-saturation control method for the preceding embodiment is implemented.

It will be understood by a person skilled in the art that all or part of the processes of the methods of the embodiments described above may be implemented by hardware commands of a computer program, which may be stored in a non-volatile computer-readable storage medium, and when executed, may include the processes of the embodiments of the methods described above. Any reference to memory, storage, databases, or other media used in the various embodiments provided herein may include, among other things, nonvolatile and/or volatile memory. Non-volatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink, DRAM (SLDRAM), Rambus direct RAM (RDRAM), direct Rambus dynamic RAM (DRDRAM), and a memory bus dynamic RAM (RDRAM) or the like.

It will be clear to a person skilled in the art that, for convenience and conciseness of description, only the above-mentioned division of functional units and modules is exemplified, and in practical applications, the above-mentioned allocation of functions can be performed by different functional units and modules, i.e. dividing the internal structure of the device into different functional units or modules, as required, to perform all or part of the functions described above.

The above embodiments are merely illustrative of the technical solutions of the present invention and are not intended to be limiting thereof; although the present invention has been described in detail referring to the foregoing embodiments, it will be understood by a person skilled in the art that modifications may be made to the technical solutions described in the foregoing embodiments or equivalents may be substituted for some of the technical features thereof; such modifications and substitutions do not depart from the spirit and scope of the embodiments of the present invention, and are intended to be included within the scope of the present invention.

1. An anti-saturation control method for an unmanned aerial vehicle based on lead correction, comprising:
determining a first rotational speed of a plurality of actuators of the unmanned aerial vehicle from a pre-set lead correction algorithm;
re-determining, when the first rotational speed satisfies a saturation limit condition, the first rotational speed satisfying the saturation limit condition as a second rotational speed in a critical saturation state;
calculating an anti-saturation acceleration corresponding to the second rotational speed from the lead correction algorithm; and
controlling the unmanned aerial vehicle to fly according to the anti-saturation acceleration.

2. The method according to claim 1, further comprising:
determining, from a flight state of the unmanned aerial vehicle, that at least one of a plurality of channels of the unmanned aerial vehicle is a target channel, other channels are reference channels, and each of the channels is configured with a respective acceleration;
the calculating the anti-saturation acceleration corresponding to the second rotational speed from the lead correction algorithm comprises:
calculating an anti-saturation acceleration of the target channel from the second rotational speed and the lead correction algorithm.

3. The method according to claim 2, wherein the calculating the anti-saturation acceleration of the target channel from the second rotational speed and the lead correction algorithm comprises:
determining an acceleration of the reference channel;
calculating a third rotational speed before the second rotational speed correction from the lead correction algorithm and the second rotational speed; and
determining the anti-saturation acceleration of the target channel from the acceleration of the reference channel, the third rotational speed and a pre-set control allocation matrix.

4. The method according to claim 1, wherein the re-determining, when the first rotational speed satisfies the saturation limit condition, the first rotational speed satisfying the saturation limit condition as the second rotational speed in the critical saturation state comprises:
determining whether a first rotational speed of the actuator is greater than a pre-set saturation rotational speed;
if so, re-determining the first rotational speed satisfying the saturation limit condition as the second rotational speed in the critical saturation state.

5. The method according to claim 1, after determining whether a first rotational speed of the actuator is greater than a pre-set saturation rotational speed, further comprising:
determining whether a first rotational speed of the plurality of actuators is greater than a pre-set saturation rotational speed;
if so, the calculating the anti-saturation acceleration corresponding to the second rotational speed from the lead correction algorithm comprises:
calculating respective anti-saturation accelerations corresponding to second rotational speeds of the plurality of actuators; and
determining the minimum of the anti-saturation accelerations as an anti-saturation acceleration.

6. The method according to claim 1, wherein the determining the first rotational speed of the plurality of actuators of the unmanned aerial vehicle from the pre-set lead correction algorithm comprises:
obtaining an initial acceleration;
determining an initial rotational speed of the plurality of actuators from the initial acceleration in combination with a pre-set control allocation equation; and
correcting the initial rotational speed according to the lead correction algorithm to obtain the first rotational speed.

7. The method according to claim 6, wherein the correcting the initial rotational speed according to the lead correction algorithm to obtain the first rotational speed comprises:
determining an inertial model of the actuator corresponding to the first rotational speed;
determining a phase compensation formula from the inertial model; and
calculating the first rotational speed from the phase compensation formula and the initial rotational speed.

8. The method according to claim 1, wherein the controlling the unmanned aerial vehicle to fly according to the anti-saturation acceleration comprises:
recalculating a first rotational speed of the actuator from the anti-saturation acceleration and a pre-set control allocation equation, wherein the recalculated first rotational speed is a rotational speed of the actuator reallocated according to the anti-saturation acceleration; and
correcting the recalculated first rotational speed according to the lead correction algorithm, recalculating a second rotational speed of the actuator, wherein the recalculated second rotational speed is an actuator rotational speed that is not performed lead correction; wherein
the actuator is made to be responsive to the recalculated second rotational speed to control the unmanned aerial vehicle to fly.

9. An anti-saturation control device for an unmanned aerial vehicle based on lead correction, comprising:
a control allocation module configured to determine a first rotational speed of a plurality of actuators of the unmanned aerial vehicle from a pre-set lead correction algorithm;
an anti-saturation feedback module configured to re-determine, when the first rotational speed satisfies a saturation limit condition, the first rotational speed satisfying the saturation limit condition as a second rotational speed in a critical saturation state;
a command correction module configured to calculate an anti-saturation acceleration corresponding to the second rotational speed from the lead correction algorithm; and
a flight control module configured to control the unmanned aerial vehicle to fly according to the anti-saturation acceleration.

10. An electronic device, comprising a memory, a processor and a computer program stored in the memory and capable of running on the processor, wherein the processor, when executing the computer program, implements the method according to claim 1.

11. A computer-readable storage medium, wherein the computer-readable storage medium has stored thereon a computer program comprising program commands which, when executed by a processor, cause the processor to perform the method according to claim 1.
